(19) United States
(12) Patent Application Publication
(10) Pub. No.: US 2026/0046777 A1
(43) Pub. Date: Feb. 12, 2026

(54) TRANSMISSION PROCESSING METHOD AND APPARATUS, TERMINAL, AND NETWORK SIDE DEVICE

(71) Applicant: VIVO MOBILE COMMUNICATION CO., LTD., Guangdong (CN)

(72) Inventor: Dongru LI, Guangdong (CN)

(73) Assignee: VIVO MOBILE COMMUNICATION CO., LTD., Guangdong (CN)

(21) Appl. No.: 19/360,437

(22) Filed: Oct. 16, 2025

Related U.S. Application Data
(63) Continuation of application No. PCT/CN2024/076691, filed on Feb. 7, 2024.

(30) Foreign Application Priority Data
Apr. 18, 2023 (CN) 202310415810.2

(51) Int. Cl. H04W 52/02; H04W 72/232

(52) U.S. Cl. CPC H04W 52/0235; H04W 72/232

(57) ABSTRACT

This application discloses a transmission processing method and apparatus, a terminal, and a network side device. The transmission processing method in embodiments of this application includes: A terminal performs a target operation, where the target operation includes at least one of the following: performing wake-up signal monitoring in a case that a first search space set group is applied; in a case that a target PDCCH skipping duration is applied, performing wake-up signal monitoring during the target PDCCH skipping duration; applying a second search space set group in a case that the target wake-up signal is detected; and in a case that the target BWP is applied, performing at least one of the following: wake-up signal monitoring, skipping PDCCH monitoring, or applying a third search space set group.

### CROSS REFERENCE TO RELATED APPLICATIONS

This application is a continuation application of PCT International Application No. PCT/CN2024/076691 filed on Feb. 7, 2024, which claims priority to Chinese Patent Application No. 202310415810.2 filed on Apr. 18, 2023, which is incorporated herein by reference in its entirety.

### TECHNICAL FIELD

This application belongs to the technical field of communication, and specifically relates to a transmission processing method and apparatus, a terminal, and a network side device.

### BACKGROUND

With the development of mobile communications, a mobile terminal may receive a wake-up signal (WUS) through a low-power wake-up radio (LP-WUR), to reduce power consumption or latency of the terminal. Currently, how to combine WUS monitoring with a related technology to reduce latency or save power becomes a problem that needs to be resolved urgently.

### SUMMARY

Embodiments of this application provide a transmission processing method and apparatus, a terminal, and a network side device.

According to a first aspect, a transmission processing method is provided, including:

A terminal performs a target operation, where the target operation includes at least one of the following:
performing wake-up signal monitoring in a case that a first search space set group is applied;
in a case that a target PDCCH skipping duration is applied, performing wake-up signal monitoring during the target PDCCH skipping duration;
applying a second search space set group in a case that a target wake-up signal is detected; and
in a case that a target BWP is applied, performing at least one of the following: wake-up signal monitoring, skipping PDCCH monitoring, or applying a third search space set group.

According to a second aspect, a transmission processing method is provided, including:

A network side device sends target indication information to a terminal, where the target indication information indicates a target association relationship, the target association relationship is used for performing a target operation by the terminal, and the target operation includes at least one of the following:
performing wake-up signal monitoring in a case that a first search space set group is applied;
in a case that a target PDCCH skipping duration is applied, performing wake-up signal monitoring during the target PDCCH skipping duration;
applying a second search space set group in a case that a target wake-up signal is detected; and
in a case that a target BWP is applied, performing at least one of the following: wake-up signal monitoring, skipping PDCCH monitoring, or applying a third search space set group.

According to a third aspect, a transmission processing apparatus is provided, including:
an execution module, configured to perform a target operation, where the target operation includes at least one of the following:
performing wake-up signal monitoring in a case that a first search space set group is applied;
in a case that a target PDCCH skipping duration is applied, performing wake-up signal monitoring during the target PDCCH skipping duration;
applying a second search space set group in a case that a target wake-up signal is detected; and
in a case that a target BWP is applied, performing at least one of the following: wake-up signal monitoring, skipping PDCCH monitoring, or applying a third search space set group.

According to a fourth aspect, a transmission processing apparatus is provided, including:
a sending module, configured to send target indication information to a terminal, where the target indication information indicates a target association relationship, the target association relationship is used for performing a target operation by the terminal, and the target operation includes at least one of the following:
performing wake-up signal monitoring in a case that a first search space set group is applied;
in a case that a target PDCCH skipping duration is applied, performing wake-up signal monitoring during the target PDCCH skipping duration;
applying a second search space set group in a case that a target wake-up signal is detected; and
in a case that a target BWP is applied, performing at least one of the following: wake-up signal monitoring, skipping PDCCH monitoring, or applying a third search space set group.

According to a fifth aspect, a terminal is provided. The terminal includes a processor and a memory. The memory stores a program or instructions executable on the processor. The program or the instructions, when executed by the processor, implement the steps of the method according to the first aspect.

According to a sixth aspect, a terminal is provided, including a processor and a communication interface, where the processor is configured to perform a target operation, and the target operation includes at least one of the following:
performing wake-up signal monitoring in a case that a first search space set group is applied;
in a case that a target PDCCH skipping duration is applied, performing wake-up signal monitoring during the target PDCCH skipping duration;
applying a second search space set group in a case that a target wake-up signal is detected; and
in a case that a target BWP is applied, performing at least one of the following: wake-up signal monitoring, skipping PDCCH monitoring, or applying a third search space set group.

According to a seventh aspect, a network side device is provided. The network side device includes a processor and a memory. The memory stores a program or instructions executable on the processor. The program or the instructions, when executed by the processor, implement the steps of the method according to the second aspect.

According to an eighth aspect, a network side device is provided, including a processor and a communication interface. The communication interface is configured to send target indication information to a terminal, where the target indication information indicates a target association relationship, the target association relationship is used for performing a target operation by the terminal, and the target operation includes at least one of the following:
performing wake-up signal monitoring in a case that a first search space set group is applied;
in a case that a target PDCCH skipping duration is applied, performing wake-up signal monitoring during the target PDCCH skipping duration;
applying a second search space set group in a case that a target wake-up signal is detected; and
in a case that a target BWP is applied, performing at least one of the following: wake-up signal monitoring, skipping PDCCH monitoring, or applying a third search space set group.

According to a ninth aspect, a readable storage medium is provided. The readable storage medium stores a program or instructions. The program or the instructions, when executed by a processor, implement the steps of the method in the first aspect or implement the steps of the method in the second aspect.

According to a tenth aspect, a wireless communication system is provided, including a terminal and a network side device, where the terminal may be configured to perform the steps of the method according to the first aspect, and the network side device may be configured to perform the steps of the method according to the second aspect.

According to an eleventh aspect, a chip is provided. The chip includes a processor and a communication interface. The communication interface is coupled to the processor. The processor is configured to execute a program or instructions, to implement the method in the first aspect or implement the method in the second aspect.

According to a twelfth aspect, a computer program/program product is provided. The computer program/program product is stored in a storage medium. The program/program product is executed by at least one processor to implement the method in the first aspect, or implement the method in the second aspect.

### BRIEF DESCRIPTION OF THE DRAWINGS

FIG. 1 is a schematic structural diagram of a network to which an embodiment of this application is applicable;

FIG. 2 is a schematic diagram of terminal wake-up provided in an embodiment of this application;

FIG. 3 is a schematic diagram of a waveform of a wake-up signal according to an embodiment of this application;

FIG. 4a and FIG. 4b are schematic flowcharts of a transmission processing method according to an embodiment of this application;

FIG. 5a and FIG. 5b are schematic flowcharts of another transmission processing method according to an embodiment of this application;

FIG. 6a and FIG. 6b are schematic diagrams of a structure of a transmission processing apparatus according to an embodiment of this application;

FIG. 7a and FIG. 7b are schematic diagrams of a structure of another transmission processing apparatus according to an embodiment of this application;

FIG. 8 is a schematic diagram of a structure of a communication device according to an embodiment of this application;

FIG. 9 is a schematic diagram of a structure of a terminal according to an embodiment of this application; and

FIG. 10 is a schematic diagram of a structure of a network side device according to an embodiment of this application.

### DETAILED DESCRIPTION

The following clearly describes the technical solutions in embodiments of this application with reference to the accompanying drawings in embodiments of this application. Apparently, the described embodiments are some of the embodiments of this application rather than all of the embodiments. All other embodiments obtained by a person of ordinary skill in the art based on embodiments of this application fall within the protection scope of this application.

In this application, the terms “first” and “second” are used to distinguish similar objects, but are not used to describe a specific sequence or order. It should be understood that the terms used in this way may be transposed where appropriate, so that embodiments of this application may be implemented in a sequence other than those illustrated or described herein. In addition, objects defined by “first” and “second” are generally of the same class and do not limit a quantity of objects. For example, one or more first objects may be arranged. In addition, “or” in this application indicates at least one of connected objects. For example, “A or B” covers three solutions, that is, solution 1: including A and excluding B; solution 2: including B and excluding A; solution 3: including both A and B. The character “/” in this specification generally indicates an “or” relationship between the associated objects.

The term “indication” in this application may be either a direct indication (or an explicit indication) or an indirect indication (or an implied indication). The direct indication may be understood as that a sender clearly informs a receiver of specific information, operations to be performed, request results, and the like in sent indication. The indirect indication may be understood as that the receiver determines corresponding information based on the indication sent by the sender, or makes a judgment and determines an operation to be executed, a request result, or the like based on the judgment result.

It should be noted that, the technology described in embodiments of this application is not limited to a long term evolution (LTE)/LTE-advanced (LTE-A) system, and may be further applied to another wireless communication system, such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, and another system. Terms “system” and “network” in embodiments of this application are usually interchangeably used, and the described technology may be applied to both the system and the radio technology mentioned above, or may be applied to another system and radio technology. A new radio (NR) system is described below as an example, and the term NR is used in most of the following description. Nevertheless, the technologies may also be applied to a system other than the NR system, such as a 6th Generation (6G) communication system.

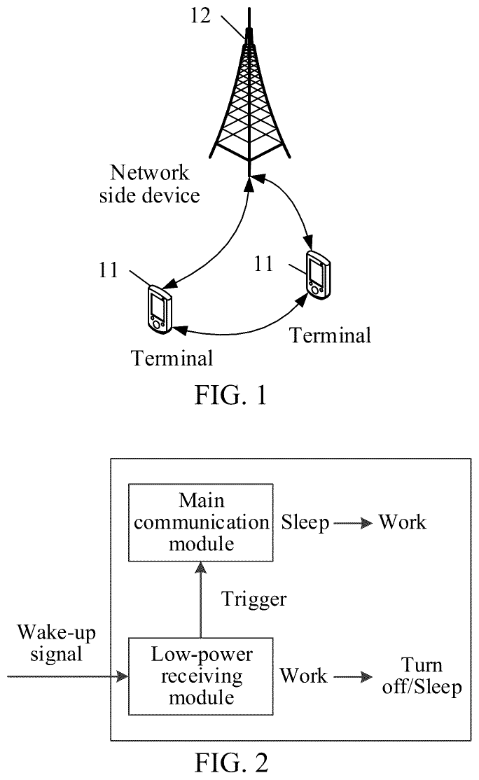

FIG. 1 is a block diagram showing a wireless communication system to which an embodiment of this application may be applied. The wireless communication system includes terminals 11 and a network side device 12. The terminal 11 may be a terminal side device such as a mobile phone, a tablet computer, a laptop computer, a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, a flight vehicle (flight vehicle), an in-vehicle device (VUE), a shipboard device, a pedestrian user equipment (PUE), a smart home appliance (a home device with a wireless communication capability, such as a refrigerator, a television, a washing machine, or furniture), a game console, a personal computer (PC), a teller machine, or a self-service machine. The wearable device includes a smart watch, a smart bracelet, a smart headset, smart glasses, smart jewelry (a smart bracelet, a smart chain bracelet, a smart ring, a smart necklace, a smart ankle bangle, a smart ankle chain, and the like), a smart wristband, smart clothing, and the like. The in-vehicle device may also be referred to as an in-vehicle terminal, an in-vehicle controller, an in-vehicle module, an in-vehicle component, an in-vehicle chip, an in-vehicle unit, or the like. It should be noted that a specific type of the terminal 11 is not limited in embodiments of this application. The network side device 12 may include an access network device or a core network device. The access network device may also be referred to as a radio access network (RAN), a wireless access network function, or a wireless access network unit. The access network device may include a base station, a wireless local area network (WLAN), an access point (AP), a wireless fidelity (WiFi) node, or the like. The base station may be referred to as a Node B (NB), an evolved Node B (eNB), a next generation Node B (gNB), a new radio Node B (NR Node B), an access point, a relay base station (RBS), a serving base station (SBS), a base transceiver station (BTS), a radio base station, a radio transceiver, a basic service set (BSS), an extended service set (ESS), a home Node B (HNB), a home evolved Node B, a transmission reception point (TRP) or some other suitable terms in the field as long as the same technical effect is achieved, and the base station is not limited to a specific technical word. It is to be noted that in embodiments of this application, introduction is made only taking the base station in the NR system as an example, and the specific type of the base station is not limited.

The core network device may include, but is not limited to, at least one of a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that, the core network device in the NR system is used only as an example for description in embodiments of this application, but a specific type of the core network device is not limited.

For ease of understanding, some contents in embodiments of this application are described below.

### I. Low-Power Receiver

The low-power receiver may be referred to as an LP-WUR or an almost-zero-power receiver (almost zero power wake up radio, AZP-WUR). A basic working principle of the LP-WUR is that a receiving end includes a first module and a second module. The first module is a main communication module configured to send and receive mobile communication data. The second module is a low-power receiving module (also referred to as a low-power wake-up receiving module) configured to receive the wake-up signal, as shown in FIG. 2. A terminal in an energy saving state turns on the low-power receiving module to monitor the LP-WUS, and turns off the main communication module. When downlink data arrives, a network side device sends the wake-up signal to the terminal. After monitoring the wake-up signal through the low-power receiving module, the terminal triggers, through a series of determining, the main communication module to switch from an off state to an on state. In this case, the low-power receiving module enters an off state from an operating state. The low-power wake-up receiving module may be continuously or discontinuously enabled. When enabled, the low power wake-up receiving module may receive a low-power wake-up signal.

### 2. Low-Power Wake-Up Signal (WUS)

To reduce reception activity of a terminal in a standby state and truly disable a radio frequency (RF) module and a baseband modem module, thereby significantly reducing power consumption of communication reception, a receiver with near-“zero” power may be provided in a receiving module of the terminal. The receiver with near-“zero” power does not require complex signal detection (such as amplification, filtering, and quantization) of the RF module and signal processing of the MODEM module, but only relies on passive matched filtering and signal processing with low power consumption.

On a base station side, a wake-up signal is triggered on demand, so that the receiver with near-“zero” power can be activated to learn of an activated notification, to trigger a series of processes in the terminal, for example, turning on a radio frequency transceiver module, a baseband processing module, and the like.

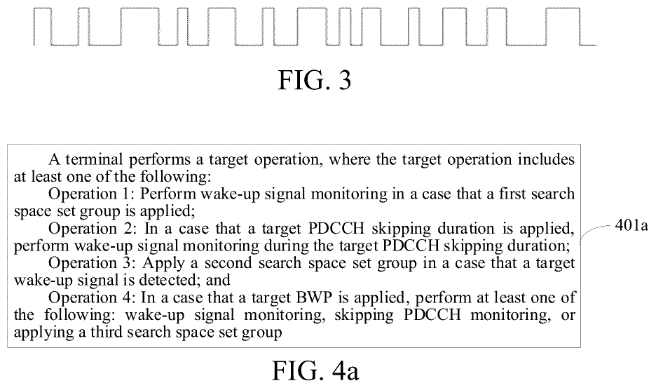

The wake-up signal is usually some simple on-off keying signals. A time domain pattern of the on-off keying signal is shown in FIG. 3. In this way, the receiver can learn of a wake-up notification through simple energy detection and subsequent possible processes such as sequence detection and recognition. In addition, when the terminal turns on the low-power wake-up receiver to receive the wake-up signal, a main receiver module may maintain operating at a relatively low power consumption level, thereby achieving power consumption saving by receiving the wake-up signal.

Reception of the low-power wake-up signal may be applied to a terminal in a radio resource control (RRC) idle (RRC_idle)/inactive state, or may be applied to a terminal in an RRC connected state (RRC_connected), to save power of the terminal.

In an embodiment, the wake-up signal mentioned in this application is the wake-up signal received by the low-power receiver.

### 3. Search Space Set Group (SSSG) Switching

A network side device can associate one or more search spaces from a type 3 physical downlink control channel (PDCCH) common search space (CSS) set (Type 3-PDCCH CSS set) or a UE-specific search space (USS) set (USS set) with at least one of a search space set group 0, a search space set group 1, or a search space set group 2.

If the terminal monitors a PDCCH on the search space set group 1, or the terminal monitors a PDCCH which located on the search space set group 1, it indicates that the terminal monitors PDCCHs corresponding to all the search spaces associated with the search space set group 1. The same is also understood for the search space set group 0 and the search space set group 2. Details are not described herein again.

A behavior of the terminal applying the search space set group 0 may be understood as: monitoring the PDCCH only on the search space set group 0, and stopping PDCCH monitoring on any search space set group other than the search space set group 0.

In other words, PDCCH monitoring can be performed only on one search space set group at a same time.

A behavior of the terminal applying the search space set group 1 may be understood as: monitoring the PDCCH only on the search space set group 1, and stopping PDCCH monitoring on any search space set group other than the search space set group 1.

A behavior of the terminal applying the search space set group 2 may be understood as: monitoring the PDCCH only on the search space set group 2, and stopping PDCCH monitoring on any search space set group other than the search space set group 2.

R17 search space set group switching timer (searchSpaceSwitch Timer-r17): a second timer for short. A behavior corresponding to expiration of the second timer is: switching to the search space set group 0, and then applying a terminal behavior (as above) corresponding to the search space set group 0. Herein, the search space set group 0 may be understood as a default search space set group.

### 4. PDCCH Skipping

The PDCCH skipping is a method for saving energy by indicating, by using a PDCCH skipping indication in downlink control information (DCI), to skip PDCCH monitoring within a time interval. For example, skipping of PDCCH monitoring within 4 slots, 8 slots, 16 slots, 4 ms, 8 ms, or 16 ms is indicated by using the PDCCH skipping DCI. Skipping monitoring means not monitoring. However, it should be noted that the PDCCH skipping can only be applied to a PDCCH corresponding to the Type3-PDCCH CSS sets or USS sets.

There are two types of terminal behaviors corresponding to an indication bit corresponding to the PDCCH skipping indication. One type is that bit values are all zero, and a corresponding terminal behavior is not performing PDCCH skipping. The other type is that bit values are not all zero, and a corresponding terminal behavior is skipping PDCCH (PDCCH corresponding to the Type3-PDCCH CSS sets or USS sets) monitoring within a specific time interval.

5. A UE monitoring behavior of BWP inactivity timer switching in combination with R17 SSSG switching or R17 PDCCH skipping

If the UE changes to a newly activated DL BWP of a serving cell before the BWP Inactivity Timer expires, the UE performs any one of the following:

When the UE is in a PDCCH skipping duration, if a search space set group list (searchSpaceGroupIdList-r17) is not provided for the UE on the newly activated DL BWP, PDCCH monitoring is resumed based on a search space set group on the newly activated BWP of the serving cell.

If searchSpaceGroupIdList-r17 is provided for the UE, the PDCCH is monitored based on the search space set group that has a group index 0 on the newly activated BWP of the serving cell.

The following describes in detail the transmission processing method provided in this embodiment of this application through some embodiments and application scenarios thereof with reference to the accompanying drawings.

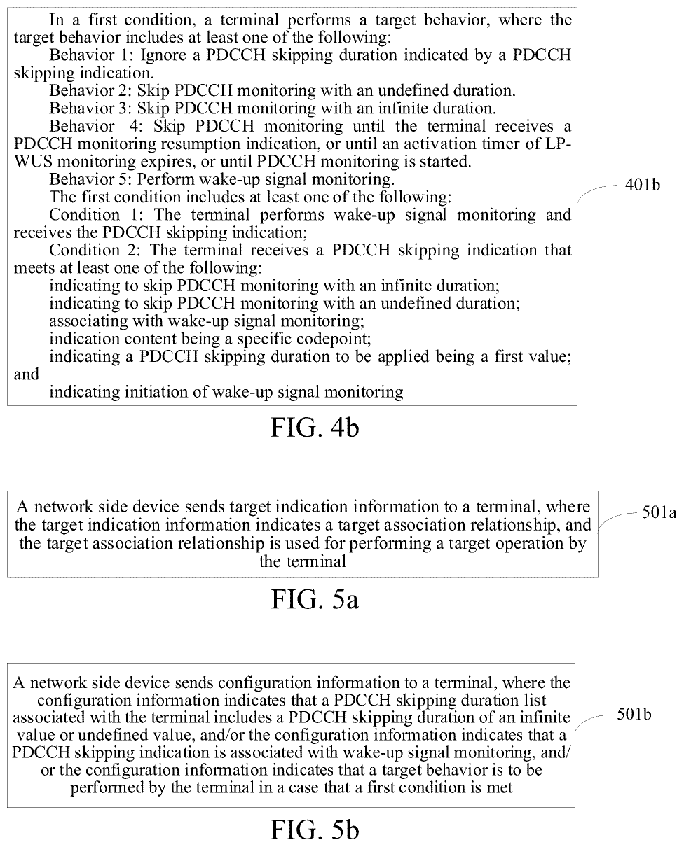

With reference to FIG. 4a, an embodiment of this application provides a transmission processing method. As shown in FIG. 4a, the transmission processing method includes the following step.

Step 401a: A terminal performs a target operation, where the target operation includes at least one of the following:
Operation 1: Perform wake-up signal monitoring in a case that a first search space set group is applied;
Operation 2: In a case that a target PDCCH skipping duration is applied, perform wake-up signal monitoring during the target PDCCH skipping duration;
Operation 3: Apply a second search space set group in a case that a target wake-up signal is detected; and
Operation 4: Perform at least one of the following: wake-up signal monitoring, skipping PDCCH monitoring, or applying a third search space set group in a case that a target BWP is applied.

Optionally, for the operation 4, in a case that a target BWP is applied, the performing at least one of the following: wake-up signal monitoring, skipping PDCCH monitoring, or applying a third search space set group may be understood as: in a case that the target BWP is applied, performing at least one of the following: wake-up signal monitoring, skipping PDCCH monitoring, or applying the third search space set group on the target BWP.

Optionally, in an embodiment, the first search space set group and/or the third search space set group is a search space set group whose index is 0.

In this embodiment of this application, the wake-up signal may be understood as or replaced with a low-power wake-up signal.

For the operation 1, applying the first search space set group may be understood as applying the first search space set group to perform PDCCH monitoring, or performing PDCCH monitoring on the first search space set group, or performing PDCCH monitoring according to the first search space set group.

For example, the terminal switches to the first search space set group to monitor a PDCCH, or the terminal monitors a PDCCH on the first search space set group and stops monitoring a PDCCH on another search space set group. According to the operation 1, in a case that the first search space set group is applied, wake-up signal monitoring is performed, so that wake-up signal monitoring may be performed only during application or activation of a specific search space set group. Therefore, the terminal may resume PDCCH monitoring when monitoring the wake-up signal, to avoid transmission latency. For example, the specific search space set group is a search space set group with very sparse PDCCH monitoring periodicity. When the terminal switches to the search space set group to perform PDCCH monitoring, the terminal may perform wake-up signal monitoring, to avoid transmission latency caused by excessively large PDCCH monitoring periodicity.

Optionally, when the terminal detects the wake-up signal, the terminal resumes PDCCH monitoring or switches to a specific search space set group to perform PDCCH monitoring.

Optionally, in some embodiments, a network side device may explicitly or implicitly indicate, by using PDCCH monitoring adaptation indication information, to apply the first search space set group.

Optionally, while monitoring the PDCCH, the terminal may monitor or not monitor a wake-up signal.

Optionally, the terminal monitors or does not monitor a wake-up signal while monitoring the PDCCH on a PDCCH monitoring occasion associated with the first search space set group. To be specific, whether the terminal can monitor the PDCCH and the wake-up signal simultaneously is configurable by a network, specified by a specification, or reported by the terminal.

In addition, in some embodiments, when the terminal is operating under the application of a search space set group with dense PDCCH monitoring periodicity, because of dense PDCCH monitoring, transmission latency is very small, and wake-up signal monitoring does not need to be performed again.

Further, in a case that the first search space set group is applied, performing wake-up signal monitoring may be understood as: The terminal simultaneously applies the first search space set group to perform PDCCH monitoring and applies wake-up signal monitoring.

For the operation 2, applying the target PDCCH skipping duration may be understood as that the terminal skips PDCCH monitoring during the target PDCCH skipping duration. According to the operation 2, in a case that the target PDCCH skipping duration is applied, because wake-up signal monitoring is performed in the PDCCH skipping duration, the terminal may resume PDCCH monitoring or stop PDCCH skipping when detecting the wake-up signal, to reduce transmission latency caused by the PDCCH skipping. Optionally, in some embodiments, the network side device may explicitly or implicitly indicate, by using PDCCH monitoring adaptation indication information, to apply the target PDCCH skipping duration.

For the operation 3, the target wake-up signal may implicitly or explicitly indicate to activate the second search space set group (or to apply the second search space set group). Applying the second search space set group may be understood as applying the first search space set group to monitor the PDCCH. Because PDCCH monitoring is started or resumed on the second search space set group after the target wake-up signal is detected, flexibility of PDCCH monitoring is improved, and power consumption or transmission latency of the terminal is reduced.

For the operation 4, applying the target BWP may be understood as activating or switching to the target BWP. For example, the terminal switches to the target BWP and performs at least one of the following: wake-up signal monitoring, skipping PDCCH monitoring, and applying a third search space set group. In some embodiments, if the terminal performs wake-up signal monitoring and skips PDCCH monitoring when the target BWP is applied, power consumption of the terminal may be reduced. In some embodiments, if the terminal performs wake-up signal monitoring and applies the third search space set group when the target BWP is applied, power consumption or transmission latency of the terminal may be reduced.

In embodiments of this application, a terminal performs a target operation, where the target operation includes at least one of the following: performing wake-up signal monitoring in a case that a first search space set group is applied; in a case that a target PDCCH skipping duration is applied, performing wake-up signal monitoring during the target PDCCH skipping duration; applying a second search space set group in a case that the target wake-up signal is detected; and performing, at least one of the following: wake-up signal monitoring, skipping PDCCH monitoring, or applying a third search space set group in a case that a target BWP is applied. In this way, because related behaviors of combining WUS monitoring and PDCCH monitoring are clarified, reducing latency or saving power.

Optionally, the target BWP may be a specific BWP indicated by the network side device, or may be a default BWP.

In some embodiments, in a case that a target bandwidth part BWP is applied, the performing at least one of the following: wake-up signal monitoring, skipping PDCCH monitoring, or applying a third search space set group includes:

The terminal performs at least one of the following: wake-up signal monitoring, skipping PDCCH monitoring, and applying the third search space set group when switching to the target BWP upon expiry of a BWP inactivity timer (bwp-InactivityTimer).

The target BWP is a default BWP.

For example, the terminal (on the target BWP) performs wake-up signal monitoring and skipping PDCCH monitoring when switching to the target BWP upon expiry of the BWP inactivity timer (bwp-InactivityTimer).

For another example, the terminal (on the target BWP) performs wake-up signal monitoring and performs PDCCH monitoring by applying the third search space set group when switching to the target BWP upon expiry of the BWP inactivity timer (bwp-Inactivity Timer).

In this embodiment of this application, applying the target BWP may alternatively be understood as or replaced with the expiration of the bwp-Inactivity Timer. Usually, when the bwp-InactivityTimer expires, the terminal switches to a default BWP. Therefore, the target operation may include: performing at least one of the following: wake-up signal monitoring skipping PDCCH monitoring, or applying the third search space set group on the default BWP when the bwp-InactivityTimer expires.

Optionally, in some embodiments, the target wake-up signal includes indication information to apply the second search space set group, or the target wake-up signal is associated with the second search space set group.

In this embodiment of this application, that the target wake-up signal includes indication information to apply the second search space set group may be understood as that the target wake-up signal explicitly indicates to activate the second search space set group. Optionally, the indication information may be index information of the second search space set group. That the target wake-up signal is associated with the second search space set group may be understood as pre-configuring or agreeing that the target wake-up signal is associated with the second search space set group, and then a network side device implicitly indicates to activate the second search space set group by sending the target wake-up signal.

Optionally, in some embodiments, the performing wake-up signal monitoring includes performing wake-up signal monitoring during non-PDCCH monitoring duration.

Optionally, in an embodiment, the performing wake-up signal monitoring during non-PDCCH monitoring duration may be understood as: monitoring the wake-up signal during a non-PDCCH monitoring occasion or a time unit in which the non-PDCCH monitoring occasion is located.

In this embodiment of this application, time for the terminal to monitor a wake-up signal does not overlap with PDCCH monitoring time. The PDCCH monitoring time is time for PDCCH monitoring based on the first search space set group or the third search space set group. For example, in a case that the first search space set group is applied, the terminal performs wake-up signal monitoring on duration in which a PDCCH associated with the first search space set group is not monitored. Alternatively, in a case that the target BWP is applied, the terminal performs, on the target BWP, wake-up signal monitoring on duration in which a PDCCH is not monitored, and applies the third search space set group. To be specific, time for the terminal to monitor the wake-up signal is time other than duration of the PDCCH associated with the first search space set group in time for applying the first search space, or time for the terminal to monitor the wake-up signal is time other than duration of a PDCCH associated with the third search space set group in time for applying the third search space set group on the target BWP.

Optionally, that the terminal performs a target operation includes:

The terminal performs the target operation based on a target association relationship, where the target association relationship includes at least one of the following:

the first search space set group is associated with a first wake-up signal monitoring configuration;
the target PDCCH skipping duration is associated with a second wake-up signal monitoring configuration;
the target wake-up signal is associated with the second search space set group; and
the target BWP is associated with a third wake-up signal monitoring configuration, where
the target association relationship is defined by a specification or configured by a network side device, and the first wake-up signal monitoring configuration, the second wake-up signal monitoring configuration, and the third wake-up signal monitoring configuration are used for performing the wake-up signal monitoring.

In this embodiment of this application, any two of the first wake-up signal monitoring configuration, the second wake-up signal monitoring configuration, and the third wake-up signal monitoring configuration may be the same or may be different. This is not further limited herein.

Optionally, in some embodiments, at least one of the first wake-up signal monitoring configuration, the second wake-up signal monitoring configuration, and the third wake-up signal monitoring configuration includes at least one of the following:
a wake-up signal type, a wake-up signal transmission configuration, a wake-up signal monitoring starting offset, a wake-up signal monitoring occasion, and wake-up signal monitoring periodicity.

Optionally, the wake-up signal type may include an RRC state for which the wake-up signal is applied, a waveform of the wake-up signal, a structure of the wake-up signal, or the like.

Optionally, a wake-up signal transmission configuration includes at least one of the following: transmit power, and time-frequency resources occupied by a single wake-up signal.

Optionally, the wake-up signal monitoring starting offset may be understood as an offset relative to the first search space set group, a target PDCCH skipping duration, or an application start location of the target BWP. To be specific, the wake-up signal monitoring starting offset is a starting offset of a next time unit relative to the first search space set group, the target PDCCH skipping duration, or an application latency corresponding to the target BWP.

Optionally, the monitoring occasion of the wake-up signal may be understood as detecting a location of the WUS.

Optionally, in some embodiments, the method further includes:

The terminal resumes PDCCH monitoring or switching to a preconfigured search space set group to perform PDCCH monitoring in a case that the terminal detects the wake-up signal or detects that the wake-up signal indicating to wake up the terminal.

For better understanding of this application, description will be provided below through some examples.

In some embodiments, the LP-WUS monitoring may be combined with the target PDCCH skipping duration.

For example, it is assumed that the network side device configures three PDCCH skipping durations for the terminal: PDCCH skipping duration 1, a PDCCH skipping duration 2, and a PDCCH skipping duration 3. In addition, the network side device further configures a PDCCH skipping duration 3 associated with the second wake-up signal monitoring configuration. A specific second wake-up signal monitoring configuration includes: at least one of a wake-up signal type, a wake-up signal transmission configuration, a wake-up signal monitoring starting offset, a wake-up signal monitoring occasion, or wake-up signal monitoring periodicity.

When the terminal receives PDCCH monitoring adaptation indication information (R17PDCCH monitoring adaptation) sent by the network side device and indicates the PDCCH skipping duration 3, the terminal skips PDCCH monitoring within the PDCCH skipping duration 3 and performs LP-WUS monitoring according to the second wake-up signal monitoring configuration.

In this way, the terminal performs LP-WUS monitoring only in the specific PDCCH skipping monitoring duration. For example, the specific PDCCH skipping monitoring duration is long, for example, 20 ms. Therefore, within the specific PDCCH skipping monitoring duration, to avoid excessively large latency caused by skipping PDCCH monitoring within an excessively long time, the terminal may monitor the LP-WUS within the specific PDCCH skipping monitoring duration, learn of arrival of a data packet in time, and resume PDCCH monitoring as soon as possible, thereby reducing the data transmission latency.

In some embodiments, the LP-WUS monitoring may be combined with the first search space set group.

It is assumed that the network side device configures three R17 search space set groups (SSSG) for the terminal: an SSSG 0, an SSSG 1, and an SSSG 2. The SSSG 0 is a default SSSG. In addition, the network side device configures the SSSG 1 (namely, the first search space set group) to associate a first wake-up signal monitoring configuration. A specific first wake-up signal monitoring configuration includes: at least one of a wake-up signal type, a wake-up signal transmission configuration, a wake-up signal monitoring starting offset, a wake-up signal monitoring occasion, or wake-up signal monitoring periodicity.

When the terminal obtains the PDCCH monitoring adaptation indication information (R17PDCCH monitoring adaptation) sent by the network and indicates to switch to the SSSG 1, the terminal applies the SSSG 1 (and stops performing PDCCH monitoring on another SSSG) and performs LP-WUS monitoring according to the first wake-up signal monitoring configuration.

Optionally, specific starting time for LP-WUS monitoring is determined based on a monitoring offset of the first wake-up signal monitoring. A starting reference point of the monitoring offset is an end position of application latency for R17 SSSG switching. That is, the LP-WUS monitoring offset is started from the application starting time point of the SSSG 1.

In this way, the terminal can apply the LP-WUS monitoring only when the first search space set group is activated. For example, the first search space set group is a power-saving search space set group, that is, a search space set group with large PDCCH monitoring periodicity. Therefore, on the power-saving search space set group, to avoid excessively large latency caused by large PDCCH monitoring periodicity, the terminal may learn of arrival of the data packet in time by monitoring the LP-WUS, and resume dense PDCCH monitoring as soon as possible, thereby reducing the data transmission latency.

Optionally, in some embodiments, the LP-WUS monitoring may be combined with expiration of the BWPinactivitytimer.

In this embodiment of this application, the network side device or a specification defines the following behaviors of the terminal.

If the terminal changes to a newly activated DL BWP of a serving cell before the BWP Inactivity Timer expires, the terminal performs any one of the following behaviors:
Behavior 1: Start to perform LP-WUS monitoring on a newly activated BWP of the serving cell (according to the third wake-up signal monitoring configuration);
Behavior 2: Start to perform LP-WUS monitoring on a newly activated BWP of the serving cell (according to the third wake-up signal monitoring configuration); and skip performing PDCCH monitoring on the newly activated BWP of the serving cell;
Behavior 3: If a search space set group list (searchSpaceGroups IdList-r17) is provided for the UE, the PDCCH is monitored according to a search space set whose group index is 0, and LP-WUS monitoring (according to the third wake-up signal monitoring configuration) on a newly activated BWP of the serving cell is performed.

Optionally, in some embodiments, when a target LP-WUS is detected, a second search space set group is applied.

Optionally, in an embodiment, it is assumed that the network side device configures LP-WUS monitoring configuration information. In addition, the network side device configures or a specification specifies that the second search space set group is applied when the target LP-WUS is detected. To be specific, when detecting the target LP-WUS, the terminal starts to perform PDCCH monitoring on the second search space set group.

Optionally, the target LP-WUS may be an LP-WUS of a specific sequence configured by the network side device.

Optionally, the target LP-WUS indicates to apply the second search space set group, or the target LP-WUS is associated with the second search space set group.

In another embodiment, the LP-WUS carries an indication of a target search space set group. After receiving the LP-WUS, the terminal applies the second search space set group based on the indication information, that is, starts to perform PDCCH monitoring or resumes PDCCH monitoring on the indicated second search space set group.

Optionally, in some embodiments, the LP-WUS monitoring may be associated with a target BWP.

In some embodiments, the network side device configures that the LP-WUS monitoring is associated with the target BWP. The terminal can only apply LP-WUS monitoring when switching to the target BWP.

Specifically, when switching to the target BWP, the terminal starts to start LP-WUS monitoring and skips PDCCH monitoring, or starts to start LP-WUS monitoring and switches to the third search space set group to perform PDCCH monitoring. In this way, the terminal can only apply the LP-WUS on the target BWP. For example, the target BWP is a power-saving BWP. When the power-saving BWP is applied, the terminal may enter LP-WUS monitoring and skip PDCCH monitoring, to obtain more power-saving gains. Alternatively, when the power-saving BWP is applied, the LP-WUS monitoring is performed while sparse PDCCH monitoring is performed on the third search space set group, to achieve power saving to some extent.

With reference to FIG. 5a, an embodiment of this application further provides a transmission processing method. As shown in FIG. 5a, the transmission processing method includes the following step.
Step 501a: A network side device sends target indication information to a terminal, where the target indication information indicates a target association relationship, the target association relationship is used for performing a target operation by the terminal, and the target operation includes at least one of the following:
performing wake-up signal monitoring in a case that a first search space set group is applied;
in a case that a target PDCCH skipping duration is applied, performing wake-up signal monitoring during the target PDCCH skipping duration;
applying a second search space set group in a case that a target wake-up signal is detected; and
in a case that a target BWP is applied, performing at least one of the following: wake-up signal monitoring, skipping PDCCH monitoring, or applying a third search space set group.

Optionally, the target wake-up signal includes indication information to apply the second search space set group, or the target wake-up signal is associated with the second search space set group.

Optionally, the target association relationship includes at least one of the following:
the first search space set group is associated with a first wake-up signal monitoring configuration;
the target PDCCH skipping duration is associated with a second wake-up signal monitoring configuration;
the target wake-up signal is associated with the second search space set group; and
the target BWP is associated with a third wake-up signal monitoring configuration, where
the first wake-up signal monitoring configuration, the second wake-up signal monitoring configuration, and the third wake-up signal monitoring configuration are used for performing a wake-up signal monitoring.

The related concepts and specific implementation procedures involved in embodiments of this application may be described with reference to the above-described terminal side method embodiments, and the present embodiments will not be repeatedly described.

The transmission processing method applied to the network side device according to this embodiment of this application corresponds to the method on the terminal side, and can also achieve the technical effect in the embodiment on the method side. Details are not described herein again.

The transmission processing method provided in this embodiment of this application may be performed by a transmission processing apparatus. In embodiments of this application, the transmission processing apparatus provided in embodiments of this application is described by using an example in which the transmission processing apparatus performs the transmission processing method.

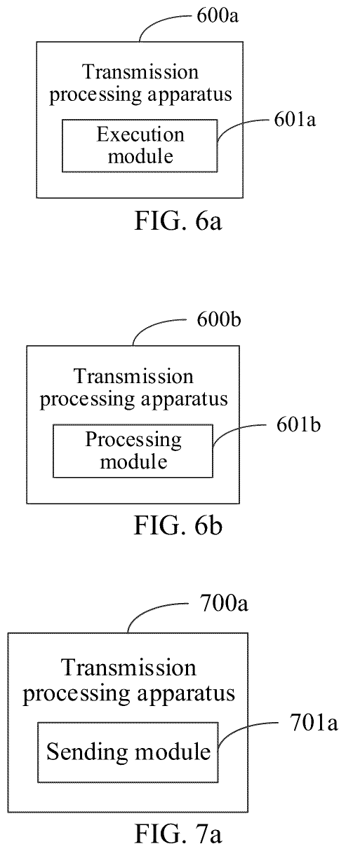

With reference to FIG. 6a, an embodiment of this application further provides a transmission processing apparatus. As shown in FIG. 6a, the transmission processing apparatus 600a includes:
an execution module 601a, configured to perform a target operation, where the target operation includes at least one of the following:
performing wake-up signal monitoring in a case that a first search space set group is applied;
in a case that a target PDCCH skipping duration is applied, performing wake-up signal monitoring during the target PDCCH skipping duration;
applying a second search space set group in a case that a target wake-up signal is detected; and
in a case that a target BWP is applied, performing at least one of the following: wake-up signal monitoring, skipping PDCCH monitoring, or applying a third search space set group.

Optionally, the execution module 601a is specifically configured to: perform at least one of the following: wake-up signal monitoring, skipping PDCCH monitoring, or applying the third search space set group in a case that the target BWP is applied due to the expiry of a BWP inactivity timer.

The target BWP is a default BWP.

Optionally, the target wake-up signal includes indication information to apply the second search space set group, or the target wake-up signal is associated with the second search space set group.

Optionally, the performing wake-up signal monitoring includes performing wake-up signal monitoring during non-PDCCH monitoring duration.

Optionally, the execution module 601a is specifically configured to perform the target operation based on a target association relationship, where the target association relationship includes at least one of the following:
the first search space set group is associated with a first wake-up signal monitoring configuration;
the target PDCCH skipping duration is associated with a second wake-up signal monitoring configuration;
the target wake-up signal is associated with the second search space set group; and
the target BWP is associated with a third wake-up signal monitoring configuration, where
the target association relationship is defined by a specification or configured by a network side device, and the first wake-up signal monitoring configuration, the second wake-up signal monitoring configuration, and the third wake-up signal monitoring configuration are used for performing a wake-up signal monitoring.

Optionally, at least one of the first wake-up signal monitoring configuration, the second wake-up signal monitoring configuration, and the third wake-up signal monitoring configuration includes at least one of the following:
a wake-up signal type, a wake-up signal transmission configuration, a wake-up signal monitoring starting offset, a wake-up signal monitoring occasion, and wake-up signal monitoring periodicity.

Optionally, the execution module 601a is further configured to: resume PDCCH monitoring or switching to a preconfigured search space set group to perform PDCCH monitoring in a case that the terminal detects the wake-up signal or detects that the wake-up signal indicating to wake up the terminal.

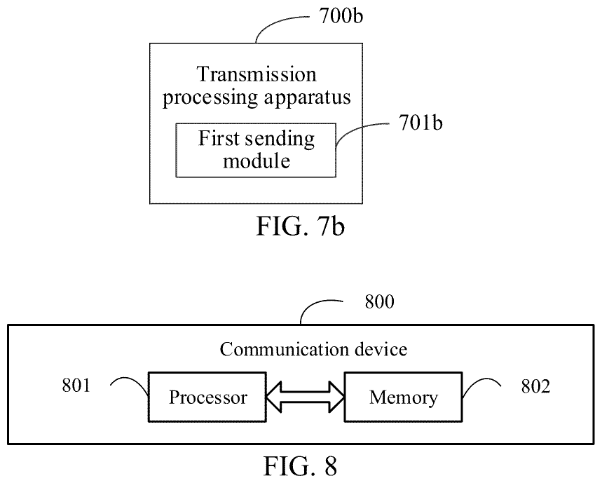

With reference to FIG. 7a, an embodiment of this application further provides a transmission processing apparatus. As shown in FIG. 7a, the transmission processing apparatus 700a includes:
a sending module 701a, configured to send target indication information to a terminal, where the target indication information indicates a target association relationship, the target association relationship is used for performing a target operation by the terminal, and the target operation includes at least one of the following:
performing wake-up signal monitoring in a case that a first search space set group is applied;
in a case that a target PDCCH skipping duration is applied, performing wake-up signal monitoring during the target PDCCH skipping duration;
applying a second search space set group in a case that a target wake-up signal is detected; and
in a case that a target BWP is applied, performing at least one of the following: wake-up signal monitoring, skipping PDCCH monitoring, or applying a third search space set group.

Optionally, the target wake-up signal includes indication information to apply the second search space set group, or the target wake-up signal is associated with the second search space set group.

Optionally, the target association relationship includes at least one of the following:
the first search space set group is associated with a first wake-up signal monitoring configuration;
the target PDCCH skipping duration is associated with a second wake-up signal monitoring configuration;
the target wake-up signal is associated with the second search space set group; and
the target BWP is associated with a third wake-up signal monitoring configuration, where
the first wake-up signal monitoring configuration, the second wake-up signal monitoring configuration, and the third wake-up signal monitoring configuration are used for performing a wake-up signal monitoring.

The transmission processing apparatus in embodiments of this application may be an electronic device, for example, an electronic device having an operating system, or a component in an electronic device, such as an integrated circuit or a chip. The electronic device may be a terminal, or may be another device other than a terminal. For example, the terminal may include, but is not limited to, the types of the terminal 11 listed above, and the another device may be a server, a network attached storage (NAS), or the like. This is not specifically limited in embodiments of this application.

The transmission processing apparatus provided in embodiments of this application can implement the processes implemented in the method embodiment of FIG. 4a and FIG. 5a, and achieve a same technical effect. To avoid repetition, details are not described herein again.

PDCCH skipping is a method in which PDCCH monitoring within a specific duration is skipped by using a PDCCH skipping indication in DCI, thereby achieving power saving. However, a duration for which PDCCH monitoring is skipped is limited by the indicated PDCCH skipping duration. When the PDCCH skipping duration ends, even if there is no data transmission for the terminal, the UE needs to resume PDCCH monitoring, which is not beneficial to power saving of the terminal. Alternatively, when there is a data transmission requirement for the terminal and the PDCCH skipping duration does not end yet, the terminal also needs to resume PDCCH monitoring until the PDCCH skipping duration ends, increasing data transmission latency. To resolve the technical problem, embodiments of this application provide a transmission processing method.

As shown in FIG. 4b, an embodiment of this application provides a transmission processing method, including but not limited to the following step.
Step 401b: In a first condition, a terminal performs a target behavior, where the target behavior includes at least one of the following:
Behavior 1: Ignore a PDCCH skipping duration indicated by a PDCCH skipping indication. Optionally, the PDCCH skipping indication may be related indication information that is of skipping PDCCH monitoring and that is indicated by a PDCCH monitoring adaption indication field (PDCCH monitoring adaptation field) in DCI. The related indication information of skipping PDCCH monitoring includes at least one of the following: indicating skipping PDCCH monitoring for a duration provided by a first value (indicates skipping PDCCH monitoring for a duration provided by the first value in the set of durations) in a PDCCH skipping duration list (pdcch-SkippingDurationList); skipping PDCCH monitoring for a duration provided by a second value in the PDCCH skipping duration list; and skipping PDCCH monitoring for a duration provided by a third value in the PDCCH skipping duration list. The network side device may configure any one of the first value, the second value, and the third value to be an infinite length or an undefined length.

For example, the terminal enables or activates the LP-WUS monitoring. When the terminal detects the PDCCH skipping indication, the terminal ignores the PDCCH skipping duration associated with the PDCCH skipping indication, and instead, resumes the PDCCH monitoring according to whether the LP-WUS is detected. Therefore, the terminal is no longer limited to skipping PDCCH monitoring at a specific time, but may always skip PDCCH monitoring, and resume PDCCH monitoring by monitoring the wake-up signal based on a location to which a service arrives next time, thereby flexibly skipping PDCCH monitoring duration, and maximally implementing power saving of the terminal without affecting service transmission efficiency. It may be understood that, the terminal performs wake-up signal monitoring while applying or executing infinite-duration PDCCH skipping monitoring, and enabling the LP-WUS monitoring refers to that the terminal is configured and activates the LP-WUS monitoring.
Behavior 2: Skip PDCCH monitoring with an undefined duration, for example, skip PDCCH monitoring without PDCCH skipping duration (skipping PDCCH monitoring without PDCCH skipping duration), or skip PDCCH monitoring with a PDCCH skipping duration with an undefined duration. For example, when the terminal detects the PDCCH skipping indication, but the PDCCH skipping indication has no association with the PDCCH skipping duration, the terminal performs PDCCH skipping monitoring with an infinite duration and executes LP-WUS monitoring during the PDCCH skipping monitoring periodicity.
Behavior 3: Skip PDCCH monitoring with an infinite duration. For example, the terminal starts the LP-WUS monitoring. When the terminal detects the PDCCH skipping monitoring indication, the terminal performs PDCCH skipping monitoring with an infinite duration, and resumes PDCCH monitoring according to whether the LP-WUS is detected.
Behavior 4: Skip PDCCH monitoring until the terminal receives a PDCCH monitoring resumption indication, or until an activation timer of LP-WUS monitoring expires, or until PDCCH monitoring is started. For example, when the terminal detects the PDCCH skipping monitoring indication, the terminal keeps skipping PDCCH monitoring until the terminal receives the PDCCH monitoring resumption indication, or until the timer of LP-WUS monitoring expires, or until PDCCH monitoring is started.
Behavior 5: Perform wake-up signal monitoring. It may be understood as that the terminal starts LP-WUS monitoring, or the terminal activates LP-WUS monitoring or applies LP-WUS monitoring.

The first condition includes at least one of the following:
Condition 1: The terminal performs wake-up signal monitoring and receives the PDCCH skipping indication; and
Condition 2: The terminal receives a PDCCH skipping indication that meets at least one of the following:
indicating to skip PDCCH monitoring with an infinite duration;
indicating to skip PDCCH monitoring with an undefined duration;
associating with wake-up signal monitoring;
indication content being a specific codepoint; for example, as specified in the specification, a second PDCCH skipping indication is associated with a specific codepoint, for example, a reserved codepoint (reserved value) in the PDCCH monitoring adaptation indication field of the DCI;
indicating a PDCCH skipping duration to be applied being a first value. For example, the first value provided in the PDCCH skipping duration list configured for the terminal by the network side device is of infinite or undefined length; when the terminal receives the PDCCH skipping indication and indicates to skip PDCCH monitoring of corresponding duration according to the first value provided in the PDCCH skipping duration list, the terminal skips PDCCH monitoring with an infinite duration; and
indicating initiation of wake-up signal monitoring.

In an embodiment, when the terminal applies or activates the LP-WUS monitoring, if the terminal receives the PDCCH skipping indication, the terminal may skip PDCCH monitoring with no limited duration. In another embodiment, when the terminal receives the PDCCH skipping indication and the PDCCH skipping indication implicitly associates LP-WUS monitoring or the PDCCH skipping indication indicates to perform/apply wake-up signal monitoring, the terminal may skip PDCCH monitoring with no limited duration.

Optionally, step 401b includes:

The terminal performs at least one of the following: skipping PDCCH monitoring with an infinite duration; skipping PDCCH monitoring within an undefined duration; and performing wake-up signal monitoring in a case that the first condition includes that the terminal receives a first PDCCH skipping indication. For example, when receiving the PDCCH skipping indication, the terminal skips PDCCH monitoring with an infinite duration. For another example, the network side device configures the PDCCH skipping indication to be associated with wake-up signal monitoring. After receiving the PDCCH skipping indication, the terminal skips PDCCH monitoring and starts wake-up signal monitoring. Alternatively, the terminal ignores the PDCCH skipping duration indicated by the PDCCH skipping indication. That is, in this case, the terminal performs PDCCH skipping monitoring with an infinite duration.

Optionally, step 401b includes:

The terminal performs at least one of the following: ignoring a PDCCH skipping duration indicated by a PDCCH skipping indication, skipping PDCCH monitoring with an infinite duration, or skipping PDCCH monitoring with an undefined duration, in a case that the first condition includes that the terminal performs wake-up signal monitoring and receives the PDCCH skipping indication. An advantage of this solution is that the network does not need to modify a configuration of a current PDCCH skipping duration. It only needs to be defined in a specification agreement manner that under this condition, the terminal skips PDCCH monitoring within infinite duration. The impact on the specification is very small. For example, when the terminal monitors the wake-up signal and receives the PDCCH skipping indication, the terminal ignores the PDCCH skipping duration associated with the PDCCH skipping indication, and instead, resumes the PDCCH monitoring according to whether the LP-WUS is detected. Therefore, the terminal is no longer limited to skipping PDCCH monitoring at a specific time, but may always skip PDCCH monitoring, and resume PDCCH monitoring by monitoring the wake-up signal based on a location to which a service arrives next time, thereby flexibly skipping PDCCH monitoring duration, and maximally implementing power saving of the terminal without affecting service transmission efficiency. It may be understood that, the terminal performs wake-up signal monitoring while applying or executing infinite-duration PDCCH skipping monitoring, and enabling the LP-WUS monitoring refers to that the terminal is configured and activates the LP-WUS monitoring.

It should be understood that the performing, by the terminal, wake-up signal monitoring and receiving a PDCCH skipping indication includes: The terminal is configured and activated monitoring of the wake-up signal. In this case (a case is after the wake-up signal monitoring already starts), the terminal receives the PDCCH skipping indication.

Optionally, the transmission processing method further includes: receiving configuration information from a network side device, where the configuration information indicates that a PDCCH skipping duration list associated with the terminal comprises a PDCCH skipping duration of an infinite value or an undefined value, and/or the configuration information indicates that the PDCCH skipping indication is associated with wake-up signal monitoring, and/or the configuration information indicates that a target behavior is to be performed by the terminal in a case that a first condition is met. In an embodiment, the network side device configures a PDCCH skipping duration list (pdcch-SkippingDurationList) in an RRC parameter. For different SCSs, an infinite duration or an undefined duration is added to a value of the PDCCH skipping duration. For example, in a pdcch-SkippingDurationList, a PDCCH skipping duration list for different SCSs is provided. A PDCCH skipping duration list corresponding to 15 kHz is {1, 2, 3, . . . , 20, 30, 40, 50, 60, 80, 100, infinite or undefined}, a PDCCH skipping duration list corresponding to 30 kHz is {1, 2, 3, . . . , 40, 60, 80, 100, 120, 160, 200, infinite or undefined}, a PDCCH skipping duration list corresponding to 60 kHz is {1, 2, 3, . . . , 80, 120, 160, 200, 240, 320, 400, infinite or undefined}, optionally, a PDCCH skipping duration list corresponding to 120 kHz is {1, 2, 3, . . . , 160, 240, 320, 400, 480, 640, 800, infinite or undefined}, a PDCCH skipping duration list corresponding to 480 kHz is {4, 8, 12, . . . , 640, 960, 1280, 1600, 1920, 2560, 3200, infinite or undefined}, and a PDCCH skipping duration list corresponding to 120 kHz is {8, 16, 24, . . . , 1280, 1920, 2560, 3200, 3840, 5120, 6400, infinite or undefined}. In another embodiment, the network side device configures a PDCCH skipping duration with an infinite duration or undefined duration to be associated with wake-up signal monitoring. When the terminal receives a PDCCH skipping indication associated with the PDCCH skipping duration with an infinite duration, the terminal performs PDCCH skipping monitoring with an infinite duration and performs (or starts) wake-up signal monitoring in the PDCCH skipping monitoring periodicity.

Optionally, the specification specifies that a value of the PDCCH skipping duration is infinite, or a value of the PDCCH skipping duration may be undefined. In an embodiment, the PDCCH skipping duration list configured by the network side device for the terminal may include values of a maximum of four PDCCH skipping durations. For another example, the specification specifies that a PDCCH monitoring adaptation indication field in the DCI can indicate up to four PDCCH skipping monitoring durations. Optionally, a fourth value is a PDCCH skipping duration length of infinite length or undefined length. For example, a value range of the PDCCH skipping duration list configured by the network side device for the terminal is {1, 2, 3, 4}, that is, a maximum of four PDCCH skipping durations may be provided for the terminal. For example, the network side device may provide four PDCCH skipping durations for the terminal by using the following RRC information:
pdcch-SkippingDurationList SEQUENCE (SIZE (1 4)) OFSCS-SpecificDuration-r17 OPTIONAL—Need R

In this embodiment of the present invention, in the first condition, the terminal may always skip PDCCH monitoring by executing a target behavior, and resume PDCCH monitoring by monitoring the wake-up signal according to a location to which a service arrives next time, thereby flexibly skipping PDCCH monitoring duration, and maximally implementing power saving of the terminal without affecting service transmission efficiency.

The transmission processing method in this embodiment of this application is described above from a terminal side. A transmission processing method from a network side device is further described below with reference to the accompanying drawings.

As shown in FIG. 5b, an embodiment of this application provides a transmission processing method, including but not limited to the following step.

Step 501b: A network side device sends configuration information to a terminal, where the configuration information indicates that a PDCCH skipping duration list associated with the terminal includes a PDCCH skipping duration of an infinite value or undefined value, and/or the configuration information indicates that a PDCCH skipping indication is associated with wake-up signal monitoring, and/or the configuration information indicates that a target behavior is to be performed by the terminal in a case that a first condition is met.

In an embodiment, the network side device configures a PDCCH skipping duration list (pdcch-SkippingDurationList) in an RRC parameter. For different SCSs, an infinite duration or an undefined duration is added to a value of the PDCCH skipping duration. In another embodiment, the network side device configures a PDCCH skipping duration with an infinite or undefined duration to be associated with wake-up signal monitoring. When the terminal receives the PDCCH skipping indication associated with the PDCCH skipping duration with an infinite duration, the terminal performs PDCCH skipping monitoring with an infinite duration and performs wake-up signal monitoring in the PDCCH skipping monitoring periodicity, so that the terminal is no longer limited to skipping PDCCH monitoring for a specific time, but can always skip PDCCH monitoring, and resumes PDCCH monitoring by monitoring the wake-up signal according to a location to which a service arrives next time, thereby flexibly skipping PDCCH monitoring duration, and maximally implementing power saving of the terminal without affecting service transmission efficiency.

The transmission processing method in this embodiment of this application is described above from the perspective of a terminal and a network side device. The following further describes the transmission processing apparatus in embodiments of this application with reference to the accompanying drawings.

As shown in FIG. 6b, an embodiment of this application provides a transmission processing apparatus 600b, including but not limited to the following functional module:
a processing module 601b, configured to perform a target behavior in a first condition, where the target behavior includes at least one of the following:
Behavior 1: Ignore PDCCH skipping duration indicated by a PDCCH skipping indication;
Behavior 2: Skip PDCCH monitoring with an undefined duration;
Behavior 3: Skip PDCCH monitoring with an infinite duration;
Behavior 4: Skip PDCCH monitoring until the terminal receives a PDCCH monitoring resumption indication, or until an activation timer of LP-WUS monitoring expires, or until PDCCH monitoring is started; and
Behavior 5: Perform wake-up signal monitoring.

The first condition includes at least one of the following:
Condition 1: The terminal performs wake-up signal monitoring and receives a PDCCH skipping indication; and
Condition 2: The terminal receives a PDCCH skipping indication that meets at least one of the following:
indicating to skip PDCCH monitoring with an infinite duration;
indicating to skip PDCCH monitoring with an undefined duration;
associating with wake-up signal monitoring;
indication content being a specific codepoint;
indicating a PDCCH skipping duration to be applied being a first value; and
indicating initiation of wake-up signal monitoring.

Optionally, the processing module 601b includes:
a first processing unit, configured to perform, in a case that the first condition includes that the terminal receives a first PDCCH skipping indication, at least one of the following:
skipping PDCCH monitoring with an infinite duration;
skipping PDCCH monitoring with an undefined duration; and
performing wake-up signal monitoring.

Optionally, the processing module 601b includes:
a second processing unit, configured to perform, in a case that the first condition includes that the terminal performs wake-up signal monitoring and receives a PDCCH skipping indication, at least one of the following: ignoring PDCCH skipping duration indicated by the PDCCH skipping indication, skipping PDCCH monitoring with an infinite duration, or skipping PDCCH monitoring with an undefined duration.

Optionally, the transmission processing apparatus further includes:
a first receiving module, configured to receive configuration information from a network side device, where the configuration information indicates that a PDCCH skipping duration list associated with the terminal comprises a PDCCH skipping duration of an infinite value or an undefined value, and/or the configuration information indicates that the PDCCH skipping indication is associated with wake-up signal monitoring, and/or the configuration information indicates that a target behavior is to be performed by the terminal in a case that a first condition is met.

As shown in FIG. 7b, an embodiment of this application provides a transmission processing apparatus 700b, including but not limited to the following functional module:
a first sending module 701b, configured to send configuration information to a terminal, where the configuration information indicates that a PDCCH skipping duration list associated with the terminal comprises a PDCCH skipping duration of an infinite value or an undefined value, and/or the configuration information indicates that the PDCCH skipping indication is associated with wake-up signal monitoring, and/or the configuration information indicates that a target behavior is to be performed by the terminal in a case that a first condition is met.

The transmission processing apparatus provided in embodiments of this application can implement the processes implemented in the method embodiment of FIG. 4b and FIG. 5b, and achieve a same technical effect. To avoid repetition, details are not described herein again.

As shown in FIG. 8, an embodiment of this application further provides a communication device 800. The communication device 800 includes a processor 801 and a memory 802. The memory 802 stores a program or instructions runnable on the processor 801. When the program or the instructions are executed by the processor 801, all steps of the embodiment of the transmission processing method are implemented, and same technical effects can be achieved. To avoid repetition, details will not be repeated herein.

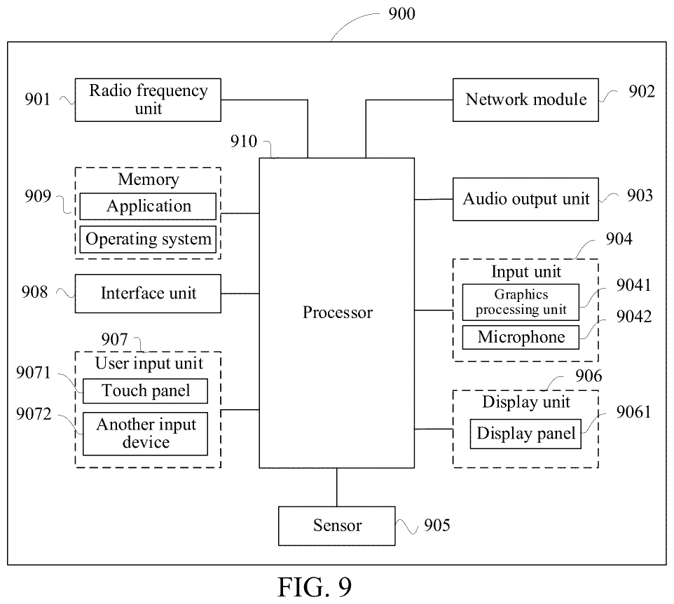

An embodiment of this application further provides a terminal, including a processor and a communication interface, where the communication interface is coupled to the processor, and the processor is configured to run a program or instructions, to implement the steps in the method embodiment as shown in FIG. 4. This terminal embodiment corresponds to the foregoing terminal side method embodiment, and each implementation process and implementation of the foregoing method embodiment can be applied to the terminal embodiment, and can achieve the same technical effects. Specifically, FIG. 9 is a schematic diagram of a hardware structure of a terminal according to an embodiment of this application.

The terminal 900 includes, but is not limited to, at least some components such as a radio frequency unit 901, a network module 902, an audio output unit 903, an input unit 904, a sensor 905, a display unit 906, a user input unit 907, an interface unit 908, a memory 909, and a processor 910.

A person skilled in the art may understand that the terminal 900 may further include a power supply (such as a battery) for supplying power to the components. The power supply may be logically connected to the processor 910 by a power management system, thereby implementing functions such as charging, discharging, and power consumption management by using the power management system. A terminal structure shown in FIG. 9 does not constitute a limitation to the terminal, and the terminal may include more or fewer components than those shown in the figure, or some components may be combined, or a different component deployment may be used, and details are not repeated herein.

It should be understood that, in this embodiment of this application, the input unit 904 may include a graphics processing unit (GPU) 9041 and a microphone 9042. The graphics processing unit 9041 performs processing on image data of a static picture or a video that is obtained by an image acquisition apparatus (for example, a camera) in a video acquisition mode or an image acquisition mode. The display unit 906 may include a display panel 9061. The display panel 9061 may be configured by using a liquid crystal display, an organic light-emitting diode, or the like. The user input unit 907 includes at least one of a touch panel 9071 and another input device 9072. The touch panel 9071 is also referred to as a touchscreen. The touch panel 9071 may include two parts: a touch detection apparatus and a touch controller. The another input device 9072 may include, but is not limited to, a physical keyboard, a functional key (such as a volume control key or a switch key), a track ball, a mouse, and a joystick. Details are not described herein again.

In this embodiment of this application, the radio frequency unit 901 receives downlink data from a network side device and then transmits the data to the processor 910 for processing. In addition, the radio frequency unit 901 may send uplink data to the network side device. Generally, the radio frequency unit 901 includes, but is not limited to, an antenna, an amplifier, a transceiver, a coupler, a low noise amplifier, a duplexer, and the like.

The memory 909 may be configured to store a software program or instructions and various data. The memory 909 may mainly include a first storage area storing a program or instructions and a second storage area storing data. The first storage area may store an operating system, an application program or instructions required by at least one function (such as a sound playback function and an image display function), and the like. Further, the memory 909 may include a volatile memory or a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), or a direct rambus random access memory (Direct Rambus RAM, DR RAM). The memory 909 in this embodiment of this application includes but is not limited to these memories and any other memory of a suitable type.

The processor 910 may include one or more processing units; and optionally, the processor 910 integrates an application processor and a modem processor. The application processor mainly processes operations relating to an operating system, a user interface, an application program, and the like. The modem processor mainly processes a wireless communication signal, such as a baseband processor. It may be understood that the modem processor may not be integrated into the processor 910.

The processor 910 is configured to perform a target operation, where the target operation includes at least one of the following:
performing wake-up signal monitoring in a case that a first search space set group is applied;
in a case that a target PDCCH skipping duration is applied, performing wake-up signal monitoring during the target PDCCH skipping duration;
applying a second search space set group in a case that a target wake-up signal is detected; and
in a case that a target BWP is applied, performing at least one of the following: wake-up signal monitoring, skipping PDCCH monitoring, or applying a third search space set group.

It can be understood that the implementation process of each implementation mentioned in this embodiment can refer to the related description of the embodiment of a terminal side transmission processing method, and the same or corresponding technical effects can be achieved, and to avoid repetition, the description thereof will not be repeated herein.

An embodiment of this application further provides a network side device, including a processor and a communication interface, where the communication interface is coupled to the processor, and the processor is configured to run a program or instructions, to implement the steps in the method embodiment as shown in FIG. 5. This network side device embodiment corresponds to the foregoing network side device method embodiment. Each implementation process and implementation of the foregoing method embodiment can be applied to this network side device embodiment, and can achieve the same technical effects.

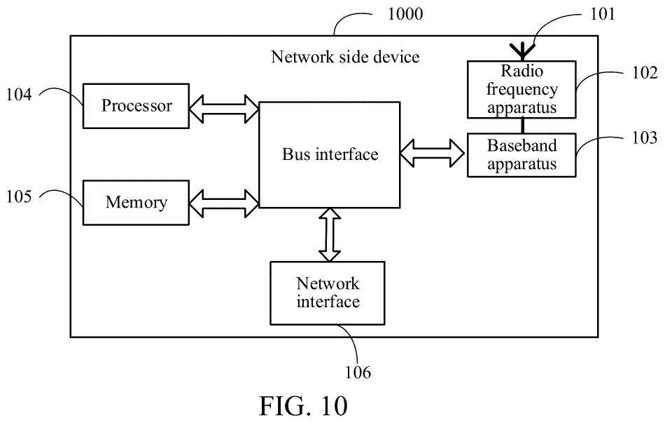

Specifically, an embodiment of this application further provides a network side device 1000. As shown in FIG. 10, the network side device 1000 includes an antenna 101, a radio frequency apparatus 102, a baseband apparatus 103, a processor 104, and a memory 105. The antenna 101 is connected to the radio frequency apparatus 102. In an uplink direction, the radio frequency apparatus 102 receives information through the antenna 101, and sends the received information to the baseband apparatus 103 for processing. In a downlink direction, the baseband apparatus 103 performs processing on to-be-sent information, and sends the to-be-sent information to the radio frequency apparatus 102. After performing processing on the received information, the radio frequency apparatus 102 sends the received information out through the antenna 101.

The method performed by the network side device in the foregoing embodiments may be implemented in the baseband apparatus 103. The baseband apparatus 103 includes a baseband processor.

The baseband apparatus 103 may include, for example, at least one baseband board. A plurality of chips are disposed on the baseband board. As shown in FIG. 10, one chip is, for example, the baseband processor, and is connected to the memory 105 via a bus interface, to invoke a program in the memory 105, to perform the network device operations shown in the foregoing method embodiments.

The network side device may further include a network interface 106. The interface is, for example, a common public radio interface (CPRI).

Specifically, the network side device 1000 in embodiments of the present invention further includes: instructions or a program stored in the memory 105 and executable on the processor 104. The processor 104 invokes the instructions or program in the memory 105 to perform the method performed by each module shown in FIG. 7, and achieves the same technical effect, which will not be described in detail herein again to avoid repetition.

Embodiments of this application further provide a readable storage medium. The readable storage medium stores a program or instructions. The program or instructions, when executed by a processor, implement various processes of the embodiments of the foregoing transmission processing method, and the same technical effects can be achieved. To avoid repetition, details are not described herein again.

The processor is a processor in the terminal described in the foregoing embodiments. The readable storage medium includes a computer-readable storage medium, such as a computer read-only memory ROM, a random access memory RAM, a magnetic disk, or an optical disk. In some examples, the readable storage medium may be a non-transitory readable storage medium.

Embodiments of this application further provide a chip. The chip includes a processor and a communication interface. The communication interface is coupled to the processor. The processor is configured to run a program or instructions, to implement various processes of the foregoing embodiments of the transmission processing method, and can achieve the same technical effects. To avoid repetition, details are not described herein again.

It should be understood that the chip mentioned in this embodiment of this application may also be referred to as a system level chip, a system chip, a chip system, a system on chip, or the like.

Embodiments of this application further provide a computer program/program product. The computer program/program product is stored in a storage medium. The computer program/program product, when being executed by at least one processor, implements various processes of the foregoing embodiments of the transmission processing method, and the same technical effects can be achieved. To avoid repetition, details are not described herein again.

Embodiments of this application further provide a wireless communication system, including: a terminal and a network side device. The terminal may be configured to perform the steps of the transmission processing method on a terminal side. The network side device may be configured to perform the steps of the transmission processing method on a network side.

It should be noted that in this specification, the term “include”, “comprise”, or any other variants thereof are intended to encompass in a non-exclusive mode, so that a process, a method, an object, or an apparatus including a series of elements not only includes those elements, but also includes other elements that are not explicitly listed, or elements that are inherent to such a process, a method, an object, or an apparatus. Without more limitations, an element defined by a sentence “including one . . . ” does not exclude existence of other same elements in the process, the method, the object, or the apparatus that includes the element. In addition, it should be noted that a scope of the method and the apparatus in the implementations of this application is not limited to performing functions according to a sequence that is shown or discussed, but may further include performing functions in a substantially simultaneous manner or in a reversed sequence according to the functions involved. For example, the described method may be performed in a different order than a described order, and various steps may be added, omitted, or combined. In addition, features described with reference to some examples may be combined in other examples.

Through the description of the foregoing implementations, a person skilled in the art may clearly understand that the methods according to the foregoing embodiments may be implemented by using computer software products and a necessary general hardware platform, and certainly, may alternatively be implemented by hardware. The computer software product is stored in a storage medium (such as ROM, RAM, magnetic disk, optical disk, etc.), and includes several instructions for causing a terminal or a network side device to perform the method described in various embodiments of this application.

Embodiments of this application are described above with reference to the accompanying drawings. However, this application is not limited to the specific implementations described above, and the specific implementations described above are only exemplary and not limitative. A person of ordinary skill in the art may make various variations under the teaching of this application without departing from the spirit of this application and the protection scope of the claims, and such implementations shall all fall within the protection scope of this application.

What is claimed is:

1. A transmission processing method, comprising:
performing, by a terminal, a target operation, wherein the target operation comprises at least one of the following:
performing wake-up signal monitoring in a case that a first search space set group is applied;
in a case that a target physical downlink control channel (PDCCH) skipping duration is applied, performing wake-up signal monitoring during the target PDCCH skipping duration;
applying a second search space set group in a case that a target wake-up signal is detected; or
in a case that a target bandwidth part (BWP) is applied, performing at least one of the following: wake-up signal monitoring, skipping PDCCH monitoring, or applying a third search space set group.

2. The method according to claim 1, in a case that a target bandwidth part (BWP) is applied, wherein the performing at least one of the following: wake-up signal monitoring, skipping PDCCH monitoring, or applying a third search space set group on the target BWP comprises:
in a case that the target BWP is applied, performing at least one of the following: wake-up signal monitoring, skipping PDCCH monitoring, or applying the third search space set group due to the expiry of a BWP inactivity timer, wherein
the target BWP is a default BWP.

3. The method according to claim 1, wherein the target wake-up signal comprises a indication information to apply the second search space set group, or the target wake-up signal is associated with the second search space set group.

4. The method according to claim 1, wherein the performing wake-up signal monitoring comprises performing wake-up signal monitoring during non-PDCCH monitoring duration.

5. The method according to claim 1, wherein the performing, by a terminal, a target operation comprises:
performing, by the terminal, the target operation based on a target association relationship, wherein the target association relationship comprises at least one of the following:
the first search space set group is associated with a first wake-up signal monitoring configuration;
the target PDCCH skipping duration is associated with a second wake-up signal monitoring configuration;
the target wake-up signal is associated with the second search space set group; or
the target BWP is associated with a third wake-up signal monitoring configuration, wherein
the target association relationship is defined by a specification or configured by a network side device, and the first wake-up signal monitoring configuration, the second wake-up signal monitoring configuration, and the third wake-up signal monitoring configuration are used for performing the wake-up signal monitoring.

6. The method according to claim 5, wherein at least one of the first wake-up signal monitoring configuration, the second wake-up signal monitoring configuration, or the third wake-up signal monitoring configuration comprises at least one of the following:
a wake-up signal type, a wake-up signal transmission configuration, a wake-up signal monitoring starting offset, a wake-up signal monitoring occasion, or wake-up signal monitoring periodicity.

7. The method according to claim 1, further comprising:
resuming, by the terminal, PDCCH monitoring or switching to a preconfigured search space set group to perform PDCCH monitoring in a case that the terminal detects a wake-up signal or detects that a wake-up signal indicating to wake up the terminal.

8. A transmission processing method, comprising:
sending, by a network side device, target indication information to a terminal, wherein the target indication information indicates a target association relationship, the target association relationship is used for performing a target operation by the terminal, and the target operation comprises at least one of the following:
performing wake-up signal monitoring in a case that a first search space set group is applied;
in a case that a target physical downlink control channel (PDCCH) skipping duration is applied, performing wake-up signal monitoring during the target PDCCH skipping duration;
applying a second search space set group in a case that a target wake-up signal is detected; or
in a case that a target BWP is applied, performing at least one of the following: wake-up signal monitoring, skipping PDCCH monitoring, or applying a third search space set group.

9. The method according to claim 8, wherein the target wake-up signal comprises indication information to apply the second search space set group, or the target wake-up signal is associated with the second search space set group.

10. The method according to claim 8, wherein the target association relationship comprises at least one of the following:
the first search space set group is associated with a first wake-up signal monitoring configuration;
the target PDCCH skipping duration is associated with a second wake-up signal monitoring configuration;
the target wake-up signal is associated with the second search space set group; or
the target BWP is associated with a third wake-up signal monitoring configuration, wherein
the first wake-up signal monitoring configuration, the second wake-up signal monitoring configuration, and the third wake-up signal monitoring configuration are used for performing the wake-up signal monitoring.

11. The method according to claim 10, wherein at least one of the first wake-up signal monitoring configuration, the second wake-up signal monitoring configuration, or the third wake-up signal monitoring configuration comprises at least one of the following:
a wake-up signal type, a wake-up signal transmission configuration, a wake-up signal monitoring starting offset, a wake-up signal monitoring occasion, or wake-up signal monitoring periodicity.

12. A transmission processing method, comprising:
performing, by a terminal, a target behavior in a first condition, wherein the target behavior comprises at least one of the following:
ignoring PDCCH skipping duration indicated by a PDCCH skipping indication;
skipping PDCCH monitoring with an undefined duration;
skipping PDCCH monitoring with an infinite duration;
skipping PDCCH monitoring until the terminal receives a PDCCH monitoring resumption indication, or until an activation timer of LP-WUS monitoring expires, or until PDCCH monitoring is started; or
performing wake-up signal monitoring, wherein
the first condition comprises at least one of the following:
performing, by the terminal, wake-up signal monitoring and receiving the PDCCH skipping indication; or
receiving, by the terminal, a PDCCH skipping indication that meets at least one of the following:
indicating to skip PDCCH monitoring with an infinite duration;
indicating to skip PDCCH monitoring with an undefined duration;
associating with wake-up signal monitoring;
indication content being a specific codepoint;
indicating a PDCCH skipping duration to be applied being a first value; or
indicating initiation of wake-up signal monitoring.

13. The method according to claim 12, wherein the performing, by a terminal, a target behavior in a first condition comprises:
in a case that the first condition comprises that the terminal receives a first PDCCH skipping indication, performing, by the terminal, at least one of the following:
skipping PDCCH monitoring with an infinite duration;
skipping PDCCH monitoring with an undefined duration; or
performing wake-up signal monitoring.

14. The method according to claim 12, wherein the performing, by a terminal, a target behavior in a first condition comprises:
performing, by the terminal in a case that the first condition comprises that the terminal performs wake-up signal monitoring and receives the PDCCH skipping indication, at least one of the following: ignoring the PDCCH skipping duration indicated by the PDCCH skipping indication, skipping PDCCH monitoring with an infinite duration, or skipping PDCCH monitoring with an undefined duration.

15. The method according to claim 12, further comprising:
receiving configuration information from a network side device, wherein the configuration information indicates that a PDCCH skipping duration list associated with the terminal comprises a PDCCH skipping duration of an infinite value or undefined value, and/or the configuration information indicates that the PDCCH skipping indication is associated with wake-up signal monitoring, and/or the configuration information indicates that the target behavior is to be performed by the terminal in a case that the first condition is met.

16. A terminal, comprising a processor and a memory, wherein the memory has a program or instructions stored therein on the memory and executable on the processor, the program or the instructions, when executed by the processor, implementing the steps of the transmission processing method according to claim 1.

17. A terminal, comprising a processor and a memory, wherein the memory has a program or instructions stored therein on the memory and executable on the processor, the program or the instructions, when executed by the processor, implementing the steps of the transmission processing method according to claim 12.

18. A network side device, comprising a processor and a memory, wherein the memory stores a program or instructions runnable on the processor, and when the program or the instructions are executed by the processor, implementing the steps of the transmission processing method according to claim 8.

19. A non-transitory readable storage medium, storing a program or instructions, wherein the program or the instructions, when executed by a processor, implementing the steps of the transmission processing method according to claim 1.

20. A non-transitory readable storage medium, storing a program or instructions, wherein the program or the instructions, when executed by a processor, implementing the steps of the transmission processing method according to claim 8.
